(19) United States
(12) Patent Application Publication
(10) Pub. No.: US 2002/0059646 A1
(43) Pub. Date: May 16, 2002

(54) Method of sequently displaying advertisement on a television screen and a digital broadcasting set-top box for performing the same

(75) Inventor: Moon-Young Kim, Kyungki-do (KR)

Correspondence Address: MERCHANT & GOULD PC, P.O. BOX 2903, MINNEAPOLIS, MN, 55402-0903, US

(73) Assignee: ALTICAST, CORP.

(21) Appl. No.: 10/008,237

(22) Filed: Nov. 7, 2001

(30) Foreign Application Priority Data
Nov. 10, 2000 (KR) 10-2000-66848

(51) Int. Cl. G06F 3/00; H04N 5/445; G06F 13/00; H04N 7/16; H04N 5/50

(52) U.S. Cl. 725/139; 725/142; 348/731; 725/42

(57) ABSTRACT

Disclosed is a method of sequently displaying advertisement on a television screen and a digital broadcasting set-top box for performing the same. The set-top box includes a tuning section for tuning a radio frequency digital broadcasting stream, a demultiplexer for separating an audio data, a video data, and an information data from the radio frequency digital broadcasting stream, a decoding section for decoding the information data, a storing section for temporary storing the decoded information data, an advertisement data processing section for searching an advertisement data among the decoded data storing in the storing section, updating the searched advertisement data, and confirming a displaying time of the advertisement data, a graphic processing section for converting the advertisement data processed by the advertisement data processing section and the information data to an image data, and a synthesizing section for synthesizing the image data and a video data decode by a media decoder.

### BACKGROUND OF THE INVENTION

1. Field of the Invention

The present invention relates to a method of sequently displaying advertisement on a television screen and a digital broadcasting set-top box for performing the same.

2. Description of the Related Art

In digital braodcasting system, modulation and demodulation of broadcasting radio is processed in digital. The digital broadcasting system supplies improved image quality and audio quality to a viewer than the analog broadcasting system, and has an advantage of improving a disadvantage of the bandwidth in an analog television broadcasting system. Moreover, while the analog television broadcasting system can provide only the image and audio to the viewer, since the digital television broadcasting system can provide a variety of information together with the image and audio, the viewer can be provided with various multimedia data. As the digital television broadcasting technology is developed, infratechnology of the broadcasting as well as the technology of providing various additional services are developed. However, in the field of advertisement, the conventional technology for the advertisement is utilized. The problems in the advertisement as follow:

First, the problem of bandwidth in the television broadcasting. In a case of advertising through the television broadcasting system, since the advertisement broadcasting uses the bandwidth which the television broadcasting uses, a main program of the television broadcasting is separated from the advertisement broadcasting whenever the advertisement is broadcasted. As the advertisement is displayed on the television screen before the main program is began, the viewer shows a tendency to change the channel. Thus, the contents of the advertisement are not efficiently conveyed to the viewer.

Second, the problem in the method of displaying the advertisement. In advertisement by using a banner on Internet and/or an Internet television, the advertisement would not be displayed according to the viewer's setting or favorite for using the Internet or watching the television. Therefore, the advertisement is stopped.

Third, the problem regarding to obtain the advertisement. In a case that the advertisement is obtained on the Internet television through the Internet, when a lot of load is required on the network traffic, the status of connection of the internet makes worse. Therefore, the viewer has difficulty of obtaining the advertisement in rapid and exact.

Forth, in order to watch the program of the digital television broadcasting, a digital broadcasting receiving set-top box should be installed in an analog television or a digital television with the digital broadcasting receiving apparatus installed therein. However, since the set-top box and the digital television are expensive, the set-top box and the digital television is a burden to the viewer.

### SUMMARY OF THE INVENTION

Therefore, the present invention is made to overcome the problems of the prior art, it is an object of the present invention to provide a method of sequently displaying an advertisement on a television screen regardless of a broadcasting bandwidth and a digital broadcasting set-top box for performing the same.

To achieve the object of the present invention, the present invention provides a set-top box for receiving a digital television broadcasting, including a tuning section for tuning a radio frequency digital broadcasting stream, a demultiplexer for separating an audio data, a video data, and an information data from the radio frequency digital broadcasting stream, a decoding section for decoding the information data, a storing section for temporary storing the decoded information data, an advertisement data processing section for searching an advertisement data among the data storing in the storing section, updating the searched advertisement data, and confirming a displaying time of the advertisement data, a graphic processing section for converting the advertisement data processed by the advertisement data processing section and the information data to an image data, and a synthesizing section for synthesizing the image data and a video data decode by a media decoder.

### BRIEF DESCRIPTION OF THE DRAWINGS

These and other objects and advantages of the present invention will become apparent and more readily appreciated from the following description of the preferred embodiments, taken in conjunction with the accompanying drawings of which:

FIG. 1 is a schematic view illustrating a digital broadcasting set-top box according to the present invention;

FIG. 2 is a flowchart showing a data updating procedure by an updating controller in FIG. 1;

FIG. 3 is a flowchart showing an advertisement information interpreting procedure by an advertisement information interpreter in FIG. 1; and

FIG. 4 is a view showing an example that an advertisement is displayed on a television screen according to the preferred embodiment of the present invention.

### DETAILED DESCRIPTION OF THE PREFERRED EMBODIMENTS

Hereinafter, the preferred embodiments of the present invention will be described in detail with reference to the accompanying drawings.

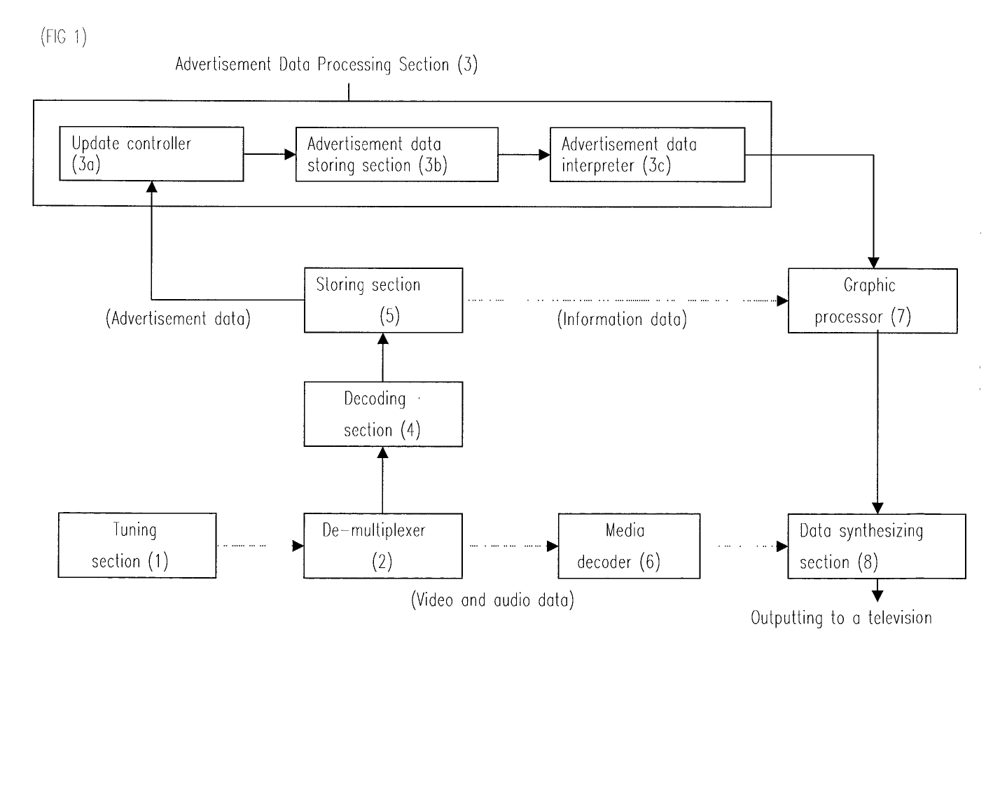

FIG. 1 is a schematic view illustrating a digital broadcasting set-top box according to a preferred embodiment of the present invention. As shown in FIG. 1, a digital television broadcasting set-top box according to the preferred embodiment of the present invention includes a tuning section 1, a de-multiplexer 2, a decoding section 4, a storing section 5, an advertisement data processing section 3, a graphic processor 7, and a data synthesizing section 8.

The tuning section 1 is a tuning circuit for receiving only a transport stream (hereinafter refer to TS) which a viewer wants to watch bandwidth among received radio frequency (hereinafter refers to RF) through a broadcast network such as a satellite broadcast network, a local cable broadcast network, and a atmospheric broadcast network. The received TS includes a video data, audio data and an information data. The information data includes a variety of information to be provided to the viewer together with the broadcast program.

The de-multiplexer 2 separates the video data, the audio data, and the information data from the received TS. The separated video and image data are decoded by the media decoder 6 and synchronized with the audio data, then displayed on the television screen, while the information data is transmitted to the decoding section 4.

The separated information data includes a usual information data and as advertisement data. The usual information data is temporary stored in the storing section 5, and displayed on the television screen according to a data broadcast schedule. Since the usual information data is displayed by the conventional method, the detailed description will be omitted.

The advertisement data is separated by the demultiplexer 2. The separated advertisement data is stored in the storing section 5 and processed by the advertisement data processing section 3 so that the advertisement data is displayed on a viewer's television screen.

Here, the advertisement data is additional data that a broadcast provider or a broadcasting station provides to the viewer. The advertisement data is stored in a certain device in the set-top box and sequently displayed at a predetermined location on the television screen when the television set or the set-top box is powered on. Therefore, the viewer can watch the advertisement. When the contents of the advertisement is modified or is automatically updated after a predetermined period, new advertisement is received into the set-top box so that the old advertisement is modified or updated.

The advertisement is processed by the advertisement data processing section 3. The advertisement data processing section 3 includes an updating controller 3a for searching whether the advertisement data is updated or not, an advertisement data storing section 3b for storing the advertisement data and the updated advertisement data by the updating controller 3a, and an advertisement data interpreter 3c in which a solution is installed. The solution interprets a displaying time and an attribute of the advertisement data stored in the advertisement data storing section 3b

The separated advertisement data by the demultiplexer 2 is temporary stored in the storing section 5. The storing section 5 is consists of Random Access Memory (RAM) and processes the advertisement data stored in the storing section 5 by a command from the updating controller 3a.

The updating controller 3a is an essential component of the set-top box of the present invention. The updating controller 3a loads the advertisement data stored in the storing section5 and executes an updating program installed therein to search the attribute of the advertisement such as type and version.

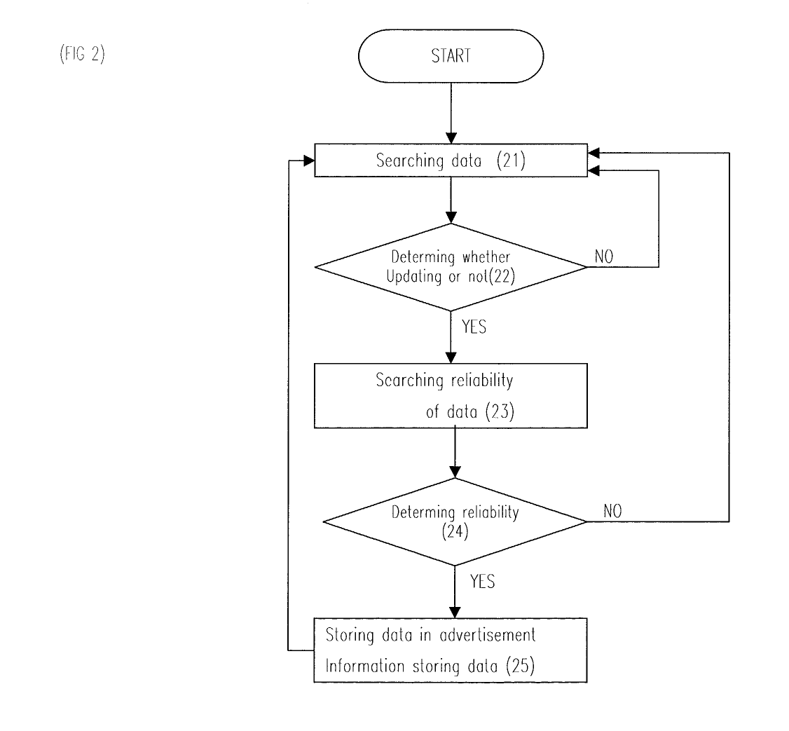

FIG. 2 is a flowchart illustrating the updating procedure of the advertisement by the updating controller 3a. The updating procedure including the steps of:

1) searching the advertisement (21);

2) determining whether to update the advertisement data according to a result of the search in the searching step (21);

3) testing reliability of the advertisement data (23);

4) determining the reliability of the advertisement according to a result of test in the testing step (23); and

5) storing an updated advertisement data in the advertisement data storing section 3b.

In the searching step (21), the updating controller 3a loads the advertisement data stored in the storing section 5 and searches the attribute of the advertisement data. In the update determining step (22), the updating program stored in the updating controller 3a determines the version and priority of the advertisement data and whether the advertisement data should be updated. In the reliability determining step (23), by utilizing security and authentication method, it is determined whether a data owner is who has an updating authority. In the reliability determining step (24), the updating program installed in the updating controller 3a determines the reliability of the advertisement data.

In the storing step (25), the updated advertisement data is stored in the advertisement data storing section 3b which has a plurality of storing blocks consist of a flash memory in which data is read and written. In the step (25), the advertisement data is updated to be displayed on the television screed of the viewer.

The advertisement data stored in the advertisement storing section 3b in the advertisement data updating procedure is processed by the information interpreter 3c installed with the solution. The solution in the information interpreter 3c interprets the displaying time and the attribute of the stored advertisement data.

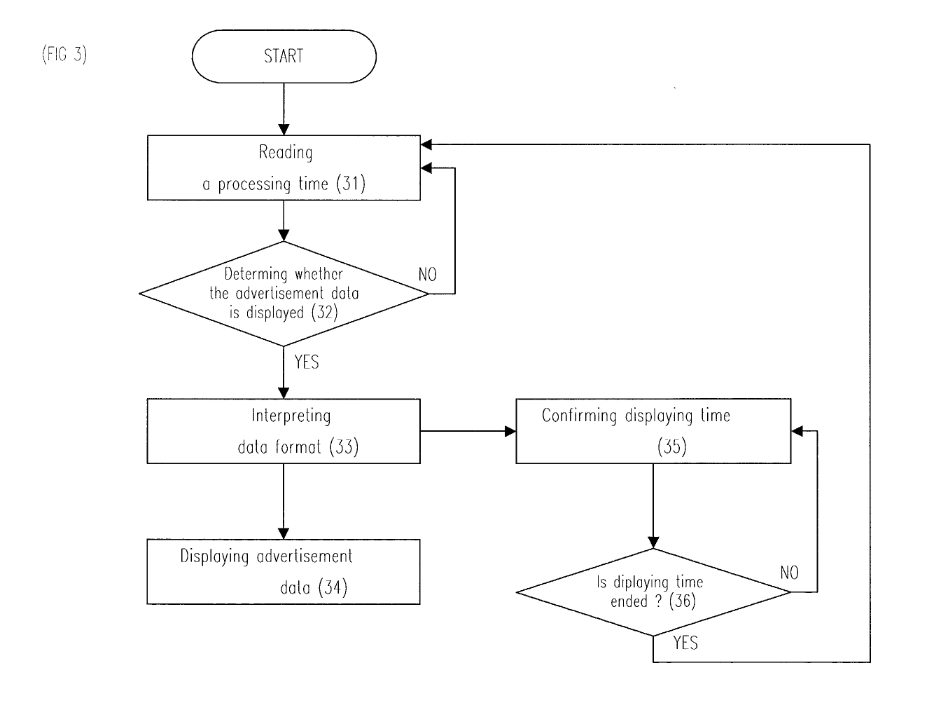

FIG. 3 is a flowchart illustrating the interpreting procedure of the advertisement data by the information interpreter 3c. As shown in the drawing, the information interpreting procedure of the advertisement data by the information interpreter 3c includes the steps as follows.

1) A step of reading a processing time (31)

The advertisement data stored in the advertisement data storing section 3b has a time information (hereinafter refers to data schedule) of starting time when each advertisement data is began to be displayed on the television screen and is terminated in accordance with broadcast program of the broadcast company. In this step (31), the time information is read.

2) A step of determining whether the advertisement data is began to be displayed (32)

According to the data schedule, the starting time when the advertisement is displayed on the television screen is determined.

3) A step of confirming a data format of the advertisement data and interpreting the data format (33)

In this step (33), the advertisement data format is confirmed, and the advertisement data is interpreted by selecting a proper expressive engine. A program for interpreting the advertisement data is installed in the information interpreter 3c and interprets the advertisement data in accordance with format of the advertisement data when the advertisement data is transported. The information interprets various items of the advertisement data such as the advertisement data schedule, the format of the advertisement data, and a graphic processing method.

4) A step of visually displaying the advertisement data by the graphic processor 7 (34)

In this step (34), the advertisement data is converted into an image data based on a result in the confirming and interpreting step (33) by the graphic processor 7 so that the advertisement data is graphically displayed.

5) A step of confirming a displaying time (35)

In this step (35), the displaying time of the advertisement data is always checked when the advertisement data is displayed on the television screen, and the displaying of the advertisement data is ended by confirming the ending time of the advertisement data.

The advertisement data processed by the information interpreter 3c is converted into an image data by the graphic processor 7, then the data synthesizing section 8 synthesizes the converted data with the audio and video data which are decoded by the media decoder 6.

The set-top box according to the present invention may be supplied to the viewer free or low in price as follows.

If an advertiser pays advertising rate to a broadcasting company, the broadcasting company orders the digital broadcasting television set-top box according to the present invention in which the contents requested by the advertiser are stored and the broadcasting company provides the set-top box to the viewer. At this case, since the advertising rate is already paid as the productive cost of the set-top box, the broadcasting company can provide the set-top box to the viewer free or low in price, and the viewer can watch the digital broadcasting television in free or by buying the set-top box low in price on the condition of watching the advertisement whenever the digital broadcast program is displayed on the television screen. Moreover, since the advertisement of the advertiser is always displayed on the television provided with the set-top box, the set-top box may be an efficient advertising media in a position of the advertiser.

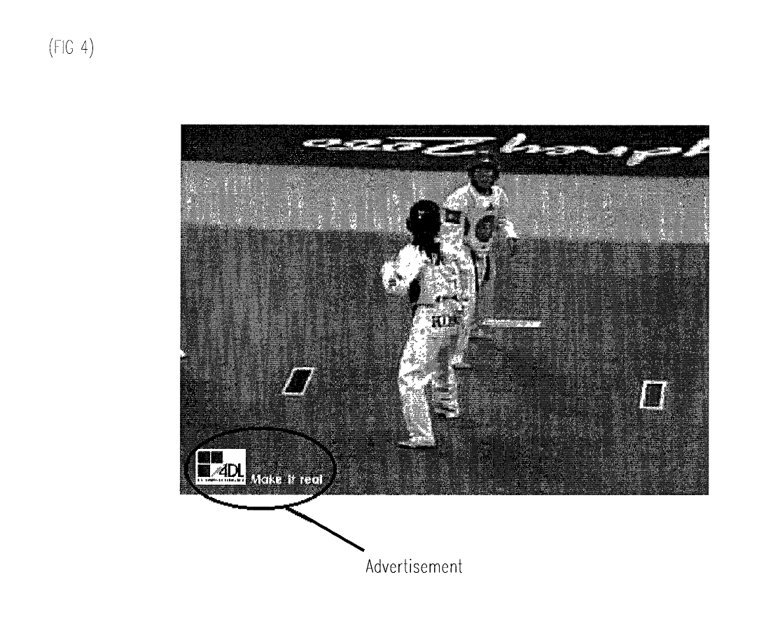

FIG. 4 shows an example for displaying the advertisement on the television screen. According the example, the advertisement is displayed at a lower left side of the television screen. The advertisement data stored in the set-top box is displayed from when the set-top box is powered on or simultaneously with powering the television.

In order to convenience of selecting the information data, the digital television is provided with a separated remote controller for selecting the contents of the advertisement data on the screen on wireless and searching desired contents. When the viewer clicks the advertisement displayed on the television screen, the detailed contents of the advertisement data is displayed on the television screen. Additionally, the viewer can change the position where the advertisement data is displayed on the television screen by using the remote controller to a desired another position. The change position of the advertisement data can be performed in the set-top box. Since the contents of the advertisement data can be stored in the viewer's computer such as a desktop computer, laptop computer, or palmtop computer, the viewer may watch the advertisement whenever he wants to watch the advertisement.

According to the present invention as describe above, by improving the conventional advertising method utilizing the broadcasting bandwidth between when the broadcast programs is broadcasted, the advertisement is sequently provided to the viewer regardless of the bandwidth.

Moreover, since the advertisement data stored in the advertisement data storing section of the set-top box is displayed on the television screen, the advertisement can be efficiently provided to the viewer without serious load on the broadcast network or traffic.

Further, according to the present invention, since the contents of the advertisement data can be stored in the personal computer, the viewer can watch the advertisement whenever he/she wants.

Since the set-top box of the present invention may be provided free or low in price by using the advertising rate which is paid by the advertiser, the viewer would purchases the set-top box in convenience and the digital broadcasting may be easily spread.

Although the preferred embodiment of the present invention has been shown and described, it will be appreciated by those skilled in the art that changes may be made in these embodiments without departing from the principles and spirit of the invention, the scope of which is defined in the claims and their equivalents.

What is claimed is:

1. A digital broadcasting set-top box comprising:
a tuning section for tuning a radio frequency digital broadcasting stream;
a demultiplexer for separating an audio data, a video data, and an information data from the radio frequency digital broadcasting stream;
a decoding section for decoding the information data;
a storing section for temporary storing the decoded information data;
an advertisement data processing section for searching an advertisement data among the decoded data storing in the storing section, updating the searched advertisement data, and confirming a displaying time of the advertisement data;
a graphic processing section for converting the advertisement data processed by the advertisement data processing section and the information data to an image data; and
a synthesizing section for synthesizing the image data and a video data decode by a media decoder.

2. The set-top box as claimed in claim 1, wherein the advertisement data processing section comprises:
an updating controller for searching whether the advertisement data is updated or not;
an advertisement data storing section for storing the advertisement data and the updated advertisement data by the updating controller; and
an advertisement data interpreter provide with a solution which interprets a displaying time and an attribute of the advertisement data stored in the advertisement data storing section.

3. An advertising method comprising the steps of:
1) tuning a radio frequency digital broadcasting stream;
2) separating an audio data, a video data, and an information data from the tuned radio frequency digital broadcasting stream;
3) searching an advertisement data among the separated information data and updating the searched advertisement data;
4) converting the updated advertisement data into an image data; and
5) synthesizing the image data and a video data.

4. The method as claimed in claim 3, wherein the searching and updating step comprises the steps of:
i) loading the advertisement data stored in the storing section and searching an attribute of the advertisement data;
ii) determining whether the advertisement data is updated or not by determining a version and a priority of the advertisement data by an updating program installed in a updating controller;
iii) determining whether a data owner is who has an updating authority by using a security and authentication method;
iv) determining a reliability of the advertisement data by an updating program installed in an updating controller; and
v) storing an updated advertisement data in the advertisement data storing section.

5. The method as claimed in claim 3, wherein the converting step comprises the steps of:
a) reading a displaying time information of the advertisement data;
b) determining a starting time when the advertisement data is began to be displayed on a television screen in accordance with the displaying time information;
c) interpreting a data schedule, a data format and a graphic processing method of the advertisement data by a program installed in an advertisement information interpreter;
d) converting the advertisement data into an image data to be displayed on the television screen based on the interpreted information; and
e) displaying the advertisement data on the television screen so that the displaying time of the converted advertisement data is always checked.

6. A advertising method by using a digital broadcasting set-top box, comprising
1) providing a digital broadcasting set-top box according to claims 1 or 2 in which contents of an advertisement ordered by an advertiser who paid an advertising rate is stored to a viewer by a broadcasting company, the digital broadcasting set-top box being produced by order from the broadcasting company, and the digital broadcasting set-top box including the contents of the advertisement; and
2) seqeuntly displaying the advertisement of the advertiser on a television screen of the viewer in which the digital broadcasting set-top box is installed.
